(19) United States
(12) Patent Application Publication
(10) Pub. No.: US 2024/0263649 A1
(43) Pub. Date: Aug. 8, 2024

(54) ACCUMULATOR WITH REINFORCING STRUCTURE

(71) Applicant: Advanced Energy Storage, LLC, Sandusky, OH (US)

(72) Inventors: Jamie A. M. O'Brien, La Salle, MI (US); Lance Warner, Sandusky, OH (US)

(73) Assignee: Advanced Energy Storage, LLC, Sandusky, OH (US)

(21) Appl. No.: 18/290,184

(22) PCT Filed: May 13, 2022
(86) PCT No.: PCT/US2022/029133

§ 371 Date: Nov. 10, 2023

Related U.S. Application Data
(60) Provisional application No. 63/220,767, filed on Jul. 12, 2021.
(60) Provisional application No. 63/188,008, filed on May 13, 2021.

(51) Int. Cl. F15B 1/24

(52) U.S. Cl. CPC F15B 1/24; F15B 2201/31; F15B 2201/4053

(57) ABSTRACT

An accumulator assembly includes a first cylindrical casing, a second cylindrical casing co-axially positioned within the first cylindrical casing, wherein a cylindrical space is formed between the first cylindrical casing and the second cylindrical casing, the space defining a gas volume, first and second end caps attached to and closing the distal ends of the first and second cylindrical casings, each end cap having four radially outwardly extending sides defining reinforcement support flanges, wherein each reinforcement support flange includes a reinforcing element engagement surface, and a reinforcing element extending around each of two opposing support flanges, such that the reinforcing element engagement surfaces define a pathway for the reinforcing elements, wherein the reinforcing elements retain the first and second end caps to axial ends of the inner and outer casings.

### CROSS-REFERENCE TO RELATED APPLICATIONS

This application claims the benefit of U.S. Provisional Applications No. 63/188,008, filed May 13, 2021, and No. 63/220,767, filed Jul. 12, 2021, the disclosures of which are incorporated herein by reference.

### BACKGROUND OF THE INVENTION

This invention relates in general to pressurized fluid storage devices generally, and in particular to pressurized accumulators having structural reinforcement elements to permit storage of fluids at high pressure.

Accumulators are known to store fluids, particularly fluids considered to be incompressible, under pressure for controlled release. The pressure is created by compressing a spring element, particularly a fluid spring element, that provides the stored energy to drive the fluid to perform work. Accumulator devices, such as those described in U.S. Pat. No. 7,661,442, are known to provide external clamping mechanisms consisting of rods to add structural support to the end caps for containment of the pressurized contents. While these structural reinforcements provide axial strength, they tend to add weight to the accumulator system and require the end caps to be larger than necessary in order to accommodate connections. Thus, it would be desirable provide an end cap restraining structure that is light weight and compact in order to improve packaging and space utilization.

### SUMMARY OF THE INVENTION

This invention relates to pressurized fluid, gas, or gas over fluid storage devices generally, and in particular to pressurized accumulators having structural reinforcement elements to permit storage of fluids at high pressure.

An accumulator assembly includes a first cylindrical casing, a second cylindrical casing co-axially positioned within the first cylindrical casing, wherein a cylindrical space is formed between the first cylindrical casing and the second cylindrical casing, the space defining a gas volume, first and second end caps attached to and closing the distal ends of the first and second cylindrical casings, each end cap having four radially outwardly extending sides defining reinforcement support flanges, wherein each reinforcement support flange includes a reinforcing element engagement surface, and a reinforcing element extending around each of two opposing support flanges, such that the reinforcing element engagement surfaces define a pathway for the reinforcing elements, wherein the reinforcing elements retain the first and second end caps to axial ends of the inner and outer casings.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of an exemplary hydraulic circuit within which a reinforced accumulator in accordance with the invention may be used.

FIG. 2 is a perspective view of a reinforced accumulator in accordance with the invention.

FIG. 3 is a is an enlarged, perspective view of an end cap and reinforcement structure of the reinforced accumulator of FIG. 2.

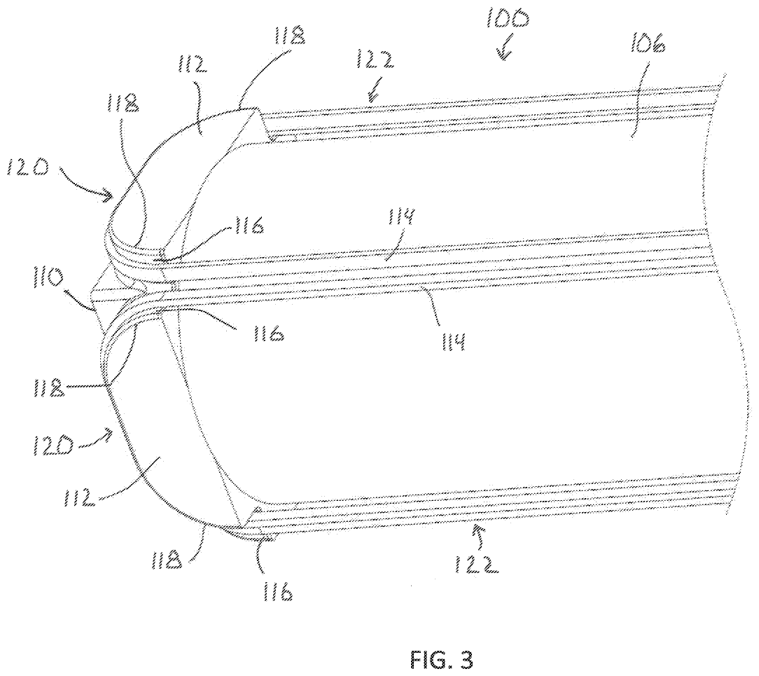

FIG. 4 is a cross sectional view taken along the line 4-4 of FIG. 2.

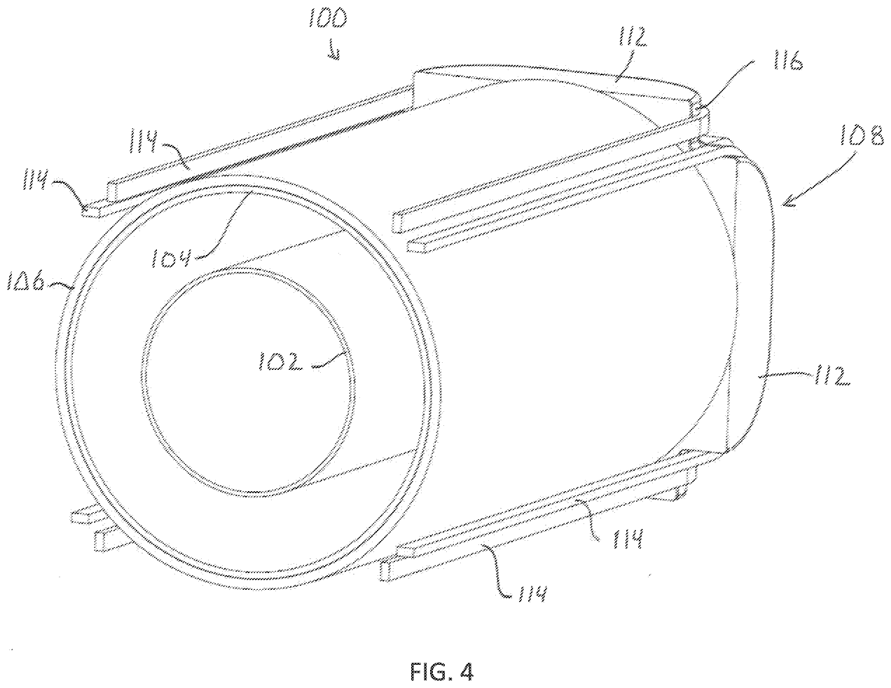

FIG. 5A is a cross sectional view taken along the lined 5A-5A of FIG. 2.

FIG. 5B is an enlarged cross-sectional view of the reinforced accumulator of FIG. 5A.

FIG. 6 is an alternate perspective view of the reinforced accumulator shown in FIG. 2 through FIG. 5B.

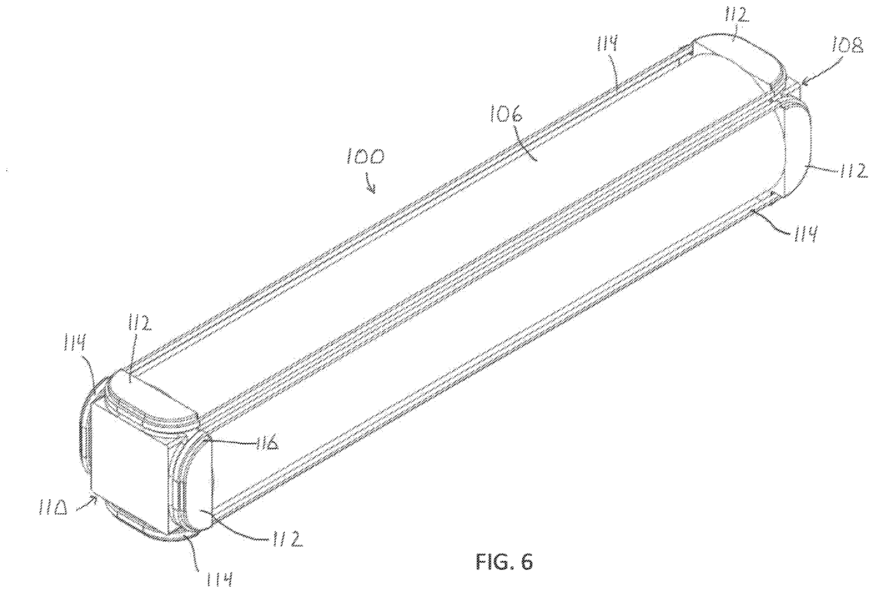

### DETAILED DESCRIPTION OF THE PREFERRED EMBODIMENT

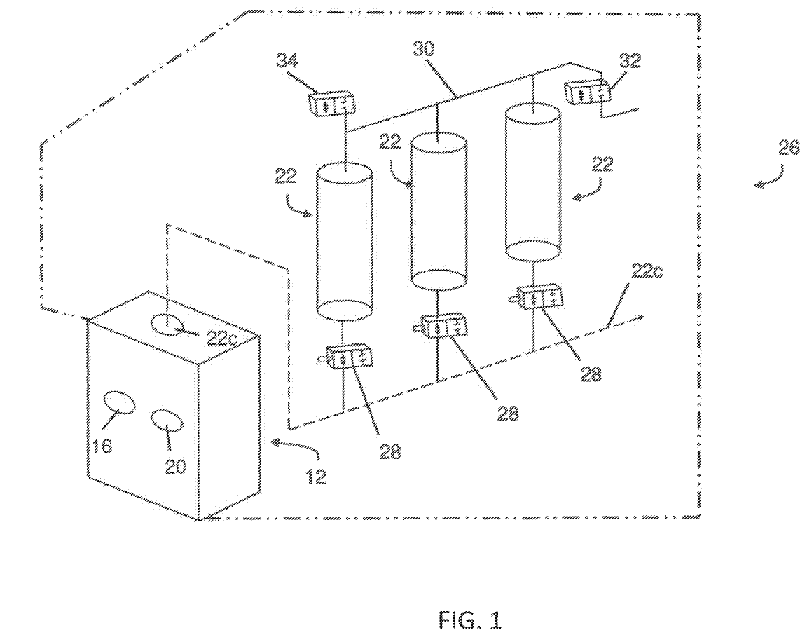

Referring now to the drawings, there is illustrated in FIG. 1 an exemplary hydraulic circuit having a plurality of accumulators as disclosed in International Application PCT/US2021/023664, the disclosure of which is incorporated by reference in its entirety. In FIG. 1, a schematic illustration of a hydraulic cell is shown generally at 26 and includes one or more hydraulic circuits. In the illustrated embodiment, a plurality of accumulators 22 are connected to a bridge 12 by an accumulator output line 22c. Each of the accumulators 22 is connected to the output line 22c through an output regulator 28. The regulator 28 is configured to control any of fluid flow rate, pressure, and/or flow direction. The regulator 28 may be activated based on the load demand required, individually, as a cascading output from each accumulator, or as a group. A pressurized chamber of each accumulator 22 is charged with a compressible medium, such as an inert gas like nitrogen (N₂), though any suitable gas may be used. The pressurized chambers of each accumulator 22 are connected to a vent line 30 in order to regulate or eliminate the pressure level of the gas. The vent line 30 may be regulated by one or more release valves 32 and 34. Alternatively, each accumulator may have a release valve connected from the pressurized chamber to the vent line 30.

In the event of an accumulator 22 failure or fluid piping failure, a particular accumulator 22 or any combination of accumulators 22 may be disabled by venting the pressurized gas therein. The affected accumulator 22 may be fluidly isolated by its associated regulator 28 and depressurized by the release valve 32 or 34 connected thereto. In the event of a system maintenance activity, the vent line 30 may be used to charge the accumulators from a charging source, such as by a source of pressurized nitrogen or by an air compressor when the inert gas is ambient air. This would permit remote location use and maintenance with minimal support supplies.

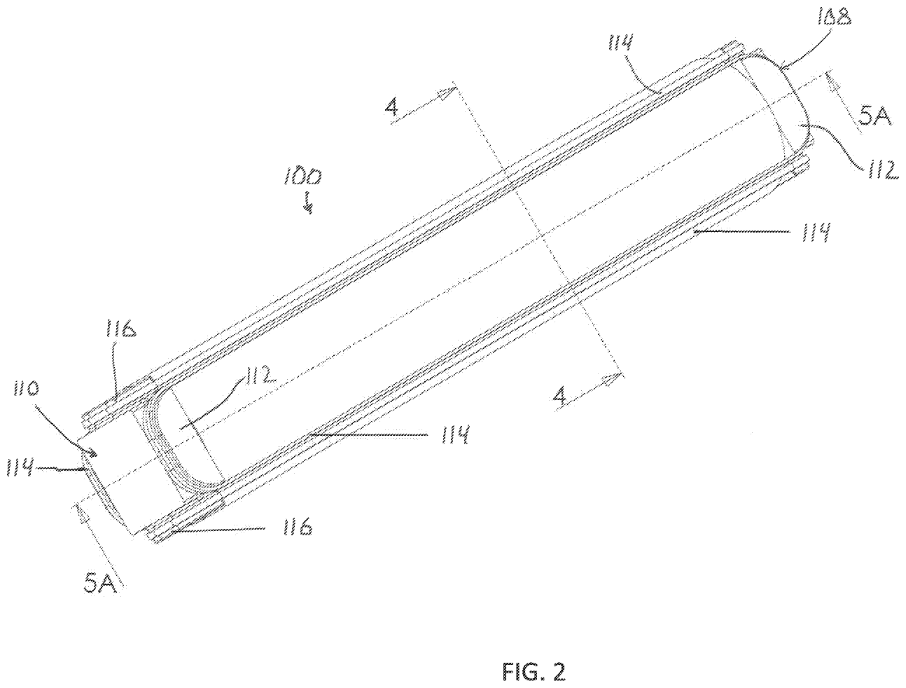

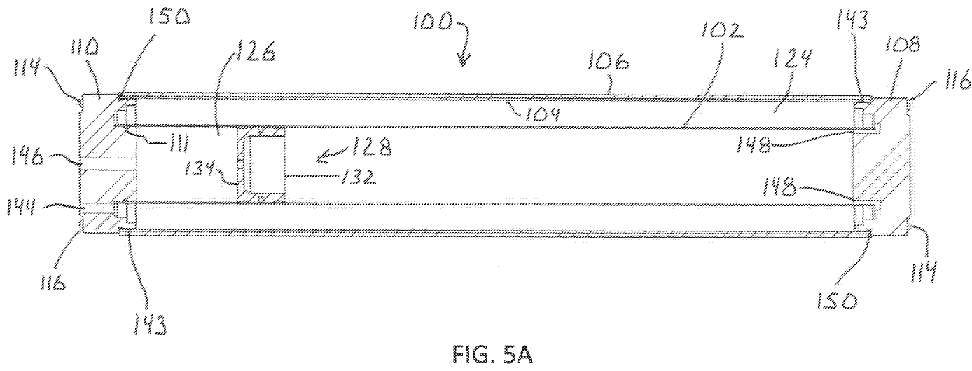

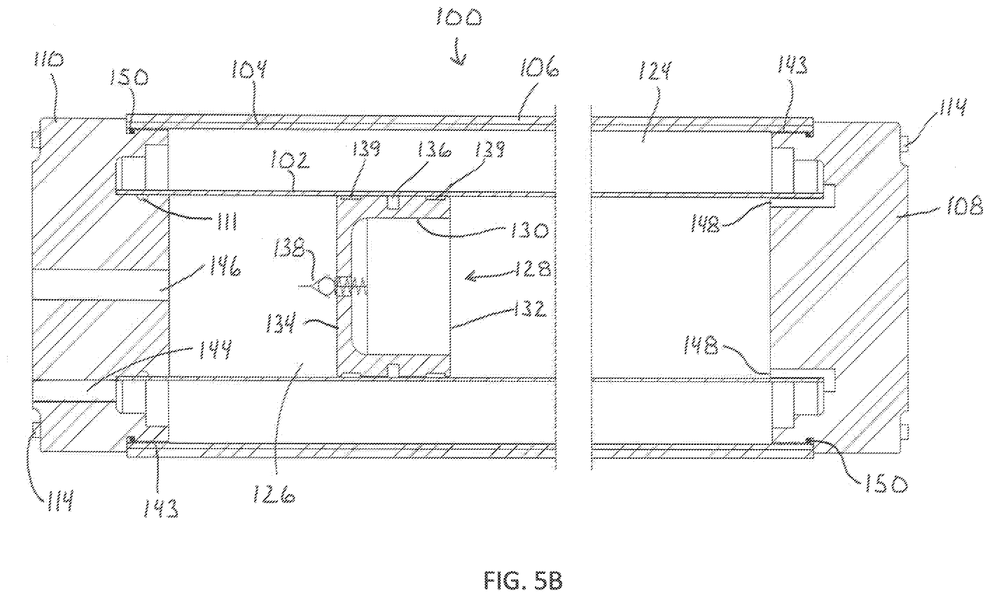

Referring to FIG. 2, an accumulator according to the invention is illustrated generally at 100. The accumulator 100 may be any type of pressurized fluid storage device, such as a piston accumulator; a bladder, metal bellows, or diaphragm accumulator; or a mechanical spring accumulator. The illustrated embodiment of the accumulator 100 is a coaxial accumulator. As shown in FIGS. 5A and 5B, the accumulator 100 includes a cylindrical inner sleeve or casing 102 within a cylindrical outer sleeve or casing 104 covered by a carbon fiber layer 106. Distal ends of the inner casing 102 and the outer casing 104 are attached to a first end cap 108 and a second end cap 110. The illustrated casings 102 and 104 may be formed from a light-weight, gas-impermeable material. Materials from which the illustrated casings 102 and 104 may be formed include, but are not limited to steel, fiberglass, composites, and other metals. The carbon fiber layer 106 may be formed by wrapping carbon fiber around the outer casing 104. The carbon fiber layer 106 improves hoop strength, improves structural integrity, and improves gas-impermeability, thus preventing gas from a gas volume 124, described below, from escaping to an exterior of the accumulator 100.

As shown in FIG. 2, the first and second end caps 108 and 110 are generally square having four radially outwardly extending sides defining reinforcement support flanges 112 that support and orient reinforcing elements 114, described in detail below. Each reinforcement support flange 112 includes a reinforcing element engagement surface 116 that defines a pathway for the reinforcing elements 114. The reinforcing element engagement surface 116 is configured with radiused transitions 118 from a transverse orientation 120 to an axial orientation 122 relative to an axis of the coaxially arranged inner and outer casings 102 and 104. As will be explained in reference to the reinforcing elements 114, the reinforcing element engagement surface 116 guides transition of the reinforcing element 114 from the axial orientation to the transverse orientation without creating a sharp transition zone.

Referring to FIG. 5A, the cylindrical outer casing 104 defines an outer wall, and the cylindrical inner casing 102 defines an inner wall of the gas volume 124. An interior of the cylindrical inner casing 102 defines a fluid volume 126. A piston 128 is mounted within the cylindrical inner casing 102 and is movable against the fluid volume 126.

The illustrated piston 128 is a substantially cup-shaped cylindrical piston having an inner surface defining an axial bore 130 extending from a first or open end 132 to a second or closed end 134 of the piston 128. The piston 128 is slidably received within the cylindrical inner casing 102. The piston 128 and the cylindrical inner casing 102 cooperate to separate the gas volume 124 from the fluid volume 126 within the cylindrical inner casing 102. A circumferential groove 136 is formed in an outer surface of the piston 128. An O-ring (not shown) is typically disposed within the groove 136 for fluidly sealing between the piston 128 and the inner surface of the cylindrical inner casing 102. The closed end 134 includes a pre-loaded check valve 138 configured as an over-pressure bypass. If desired, a sensor and alarm system (not shown) may be provided within the accumulator 100 to alert an operator when the check valve 138 is actuated in an over-pressure situation. Thus, the check valve 138 allows bypass fluid leakage in the event of an undesirable increased differential fluid pressure occurring in the fluid volume 126 that may cause structural damage to the inner casing 102.

Additionally, at least one circumferential wear groove 139 is also formed on each side of the O-ring groove 136. Wear rings (not shown) are disposed within the grooves 139 to reduce wear between the piston 128 and the inner casing 102 as the piston 128 slides within the inner casing 102 during operation of the accumulator 100.

In one embodiment, the fluid volume 126 uses a hydraulic oil, though any incompressible or marginally compressible fluid may be used. As used herein, “gas” refers to the compressible material forming the gas spring or energy storage material and “fluid” refers to the hydraulic oil or other fluid used as the energy transfer material. The gas volume 124 is in fluid communication with open end 132 of the piston 128 and the hydraulic fluid is in fluid communication with closed end 134 of the piston 128.

The first and second end caps 108 and 110 are configured to seal off the respective gas and fluid volumes 124 and 126. In the illustrated embodiment, the end caps 108 and 110 are attached to the outer casing 104 by a threaded connection 143. Alternatively, the end caps 108 and 110 may be attached to the outer casing 104 by means including but not limited to welding, brazing, a press fit, an O-ring, and other conventional sealing means. As shown in FIG. 5B, the end cap 110 includes a circumferential groove 111 is formed in an outer surface of the end cap 110. An O-ring (not shown) is typically disposed within the groove 111 for fluidly sealing between the end cap 110 and the inner surface of the cylindrical inner casing 102.

The end cap 110 is illustrated with a gas charging port 144 and a hydraulic fluid port 146, although either of the end caps 108 and 110 may include one or both of these ports. Advantageously, the gas charging port 144 and the hydraulic fluid port 146 the end cap 110 and are thus both at one end of the accumulator 100. The charging port 144 may include a two-way valve (not shown) and thus function as a gas inlet and as a gas outlet for the safe discharge of gas from the gas volume 124. Similarly, the hydraulic fluid port 146 may also include a two-way valve (not shown) to regulate the fluid flow into and out of the fluid volume. Alternatively, valves may be part of a hydraulic circuit, such as disclosed in International Application PCT/US2021/023664. The illustrated first end cap 108 includes two gas passageways 148 that permit communication of the gas volume 124 with the open end 132 of the piston 128.

In the illustrated embodiment, the reinforcing element 114 is formed from a plurality of filaments or fibrous material that may be separate or bonded together. The filaments or fibrous material may be formed from a metal material, such as wire rope, carbon fiber, aramid fiber, fiberglass, nanocomposites, or any other type of load bearing material that can be wound or formed onto the end caps 108 and 110. The reinforcing elements 114 may be encapsulated with a containment material such as an epoxy resin, vinyl ester resin, or other material that bonds the fibers together, either as a pre-impregnated (prepreg) fiber or coated after the fibers are installed. Such a bonded fiber structure aids in directing the load path within the reinforcing elements 114 to be predominantly in tension, which uses the strongest load orientation of the fibers. Alternatively, the fibers may be woven tows of fibers such as longitudinally oriented fibers with hoop-oriented fibers.

In one embodiment of a process to form the accumulator 100, the end caps 108 and 110 are placed to seal the distal ends of the of the inner casing 102 and the outer casing 104 and defining the gas and fluid volumes 124 and 126, respectively. The internal components such as the piston 128, bladders, diaphragms, and the like are installed prior to sealing. The end caps 108 and 110 are oriented so that the axial portions of the reinforcing element engagement surfaces 116 of each end cap 108 and 114 are substantially in line. The fibrous material of the reinforcing elements 114 is then wound over the reinforcing element engagement surfaces 116 from one end cap to the other. The reinforcing elements 114 may be further bound with any restraining structure, such as a formed and crimped sleeve (not shown), along at least the axial length of each reinforcing element 114 to prevent damage from impact loads.

Advantageously, the illustrated embodiment of the accumulator 100 relies on the reinforcing elements 114 to retain the end caps 108 and 110 to the axial ends of the inner and outer casing 102 and 104, and control axial stress created by increasing the pressure inside the accumulator 100 beyond that of the environment outside the accumulator 100. A preload is placed on the reinforcing elements 114 that is adequate to mitigate excessive movement of the endcaps 108 and 110 and maintains a barrier seal using and/or thread sealants, conventional seals, such as the seal 150 or any other process that secures and seals each of the end caps 108 and 110 to the assembled inner and outer casings 102 and 104. Advantageously, the seal 150 functions to prevents gas from the gas volume 124 from escaping to an exterior of the accumulator 100.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An accumulator assembly, comprising:
a first cylindrical casing;
a second cylindrical casing co-axially positioned within the first cylindrical casing, wherein a cylindrical space is formed between the first cylindrical casing and the second cylindrical casing, the space defining a gas volume;
first and second end caps attached to and closing the distal ends of the first and second cylindrical casings, each end cap having four radially outwardly extending sides defining reinforcement support flanges, wherein each reinforcement support flange includes a reinforcing element engagement surface; and
a reinforcing element extending around each of two opposing support flanges, such that the reinforcing element engagement surfaces define a pathway for the reinforcing elements, the reinforcing elements retaining the first and second end caps to axial ends of the inner and outer casings.

2. The accumulator assembly according to claim 1, wherein an interior of the second cylindrical casing defines a fluid volume, the accumulator assembly further including a piston mounted within the second cylindrical casing and movable against the fluid volume.

3. The accumulator assembly according to claim 2, wherein the reinforcing elements are further configured to control axial stress created when pressure inside the accumulator is increased beyond that of an environment outside the accumulator.

4. The accumulator assembly according to claim 2, wherein each reinforcing element engagement surface is configured with radiused transitions that extend from a transverse orientation to an axial orientation, the radiused transitions thus guiding transition of the reinforcing elements from the axial orientation to the transverse orientation without creating a sharp transition zone.

5. The accumulator assembly according to claim 2, wherein a carbon fiber layer is attached to an outer surface for the first cylindrical casing.

6. The accumulator assembly according to claim 4, wherein the reinforcing element is formed from fibrous material.

7. The accumulator assembly according to claim 6 wherein the fibrous material is one of a metal material, a carbon fiber, an aramid fiber, fiberglass material, and nanocomposite fibers.

8. The accumulator assembly according to claim 2, wherein the piston includes a pre-loaded check valve configured as an over-pressure bypass.

9. The accumulator assembly according to claim 8, wherein the piston is a cup-shaped cylindrical piston having an inner surface defining an axial bore extending from an open end to a closed end of the piston, wherein the piston is slidably received within the cylindrical inner casing, and wherein the piston and the cylindrical inner casing cooperate to separate the gas volume from the fluid volume within the cylindrical inner casing.

10. The accumulator assembly according to claim 9, wherein the check valve allows bypass fluid leakage when a predetermined increased differential fluid pressure occurs in the fluid volume.

11. The accumulator assembly according to claim 10, further including a sensor and alarm system within the accumulator assembly configured to alert an operator when the check valve is actuated in an over-pressure situation.

12. The accumulator assembly according to claim 11, wherein a carbon fiber layer is attached to an outer surface of the first cylindrical casing.

13. The accumulator assembly according to claim 12, wherein the carbon fiber layer is formed by wrapping carbon fiber around the first cylindrical casing, and wherein the carbon fiber layer improves hoop strength, improves structural integrity, and improves gas-impermeability.

14. The accumulator assembly according to claim 2, wherein the first and second end caps are attached to the first cylindrical casing by one of a threaded connection, welding, brazing, a press fit, and an O-ring.

15. An accumulator assembly, comprising:
a first cylindrical casing;
a second cylindrical casing co-axially positioned within the first cylindrical casing, wherein a cylindrical space is formed between the first cylindrical casing and the second cylindrical casing, the space defining a gas volume, and wherein an interior of the second cylindrical casing defines a fluid volume;
a piston mounted within the second cylindrical casing and movable against the fluid volume, the piston having a pre-loaded check valve configured as an over-pressure bypass;
a carbon fiber layer attached to an outer surface of the first cylindrical casing;
first and second end caps attached to and closing the distal ends of the first and second cylindrical casings, each end cap having four radially outwardly extending sides defining reinforcement support flanges, wherein each reinforcement support flange includes a reinforcing element engagement surface, and wherein the first and second end caps are attached to the first cylindrical casing by a threaded connection; and
a reinforcing element extending around each of two opposing support flanges, such that the reinforcing element engagement surfaces define a pathway for the reinforcing elements, the reinforcing elements retaining the first and second end caps to axial ends of the inner and outer casings.

16. The accumulator assembly according to claim 15, wherein the reinforcing elements are further configured to control axial stress created when pressure inside the accumulator is increased beyond that of an environment outside the accumulator.

17. The accumulator assembly according to claim 15, wherein each reinforcing element engagement surface is configured with radiused transitions that extend from a transverse orientation to an axial orientation, the radiused transitions thus guiding transition of the reinforcing elements from the axial orientation to the transverse orientation without creating a sharp transition zone.

18. The accumulator assembly according to claim 17 wherein the fibrous material is one of a metal material, a carbon fiber, an aramid fiber, fiberglass material, and nanocomposite fibers.

19. The accumulator assembly according to claim 15, wherein the piston is a cup-shaped cylindrical piston having an inner surface defining an axial bore extending from an open end to a closed end of the piston, wherein the piston is slidably received within the cylindrical inner casing, and wherein the piston and the cylindrical inner casing cooperate to separate the gas volume from the fluid volume within the cylindrical inner casing.

20. The accumulator assembly according to claim 19, wherein the check valve allows bypass fluid leakage when a predetermined increased differential fluid pressure occurs in the fluid volume.
